(19) United States
(12) Patent Application Publication
(10) Pub. No.: US 2010/0107153 A1
(43) Pub. Date: Apr. 29, 2010

(54) METHOD OF INSTALLING INTEGRATED FILE AND IMAGE FORMING APPARATUS FOR INSTALLING THE INTEGRATED FILE THEREIN

(75) Inventor: Jung-hyuk Kwon, Suwon-si (KR)

Correspondence Address: STEIN MCEWEN, LLP, 1400 EYE STREET, NW, SUITE 300, WASHINGTON, DC, 20005, US

(73) Assignee: Samsung Electronics Co., Ltd., Suwon-si (KR)

(21) Appl. No.: 12/536,613

(22) Filed: Aug. 6, 2009

(30) Foreign Application Priority Data
Oct. 28, 2008 (KR) 2008-106117

(51) Int. Cl. G06F 9/445

(52) U.S. Cl. 717/175; 717/174

(57) ABSTRACT

A method of installing an integrated file, and an image forming apparatus to install the integrated file therein, the method including: analyzing information of a package file, which is a package of files to be installed in the image forming apparatus, by receiving the package file and separating a metadata file describing package file information from the package file; managing files installed in the image forming apparatus by analyzing the metadata file, and when a file, of the package file, to be installed in the image forming apparatus is determined as a result of the analysis, requesting an installer to install the file; and installing, by the installer, the file in the image forming apparatus. Accordingly, various files are installed at once by using one integrated file, and thus an easy installation method is provided and a version of a file is managed by supporting a metadata file.

### CROSS-REFERENCE TO RELATED APPLICATION

This application claims the benefit of Korean Patent Application No. 10-2008-0106117, filed on Oct. 28, 2008 in the Korean Intellectual Property Office, the disclosure of which is incorporated herein in its entirety by reference.

### BACKGROUND OF THE INVENTION

1. Field of the Invention

Aspects of the present invention relate to installing a file in an image forming apparatus, and more particularly, to a method of installing an integrated file in an image forming apparatus, wherein various types of files (such as an application program, a driver, and firmware) are integrated to be installed in the image forming apparatus, and an image forming apparatus to install the integrated file therein.

2. Description of the Related Art

Recently, various pieces of binary data, such as a user application and user data, including firmware and a driver, are being installed or deleted in printers (including multifunction devices). Here, various methods are used to install the binary data, and a developer and a user are inconvenienced by such various methods. Specifically, open platform multifunction devices or printers use operations to newly add, revise, or delete firmware, a driver, or an extended application. Such adding, revising, or deleting is performed by a corresponding installer.

An application installer installs an application program in a multifunction device or a printer. Specifically, the application installer installs the application program in a remote user interface (UI) form via a web browser. A driver installer installs a driver in a multifunction device or a printer. Specifically, the driver installer installs a driver in various methods, via a universal serial bus (USB), a network, or a remote UI, according to a company or a model of the multifunction device or the printer. A firmware installer updates system firmware by transmitting a firmware file from a host via a USB cable.

As above, different methods are used to install firmware, a driver, and an application in a multifunction device or a printer according to a format and a process of the firmware, the driver, and the application. Accordingly, a user and an operator may be confused while installing the firmware, the driver, and/or the application. Moreover, when various files are installed, the user may be inconvenienced as the various files are separately installed.

### SUMMARY OF THE INVENTION

Aspects of the present invention provide a method of installing an integrated file in an image forming apparatus, wherein an application program, a driver, firmware, and data are integrated in one file to be installed in the image forming apparatus. Aspects of the present invention also provide an image forming apparatus, wherein various types of files, such as an application program, a driver, firmware, and data, are integrated in one file to be installed in the image forming apparatus.

According to an aspect of the present invention, there is provided a method of installing an integrated file in an image forming apparatus, the method including: receiving, by the image forming apparatus, a first package file including at least one installation target file to be installed in the image forming apparatus and a metadata file; analyzing the metadata file; determining an installation target file, of the at least one installation target file, to be installed according to a result of the analysis; and installing the determined installation target file in the image forming apparatus.

According to another aspect of the present invention, there is provided an image forming apparatus including: a data receiver to receive a first package file including at least one installation target file to be installed in the image forming apparatus and a metadata file; a storage unit to store the at least one installation target file and management information of the at least one installation target file; and a controller to analyze the metadata file describing information about the first package file, to store the at least one installation target file in the storage unit, to determine an installation target file, from the at least one installation target file, to be installed according to the analysis of the metadata file, and to install the determined installation target file in the image forming apparatus.

According to another aspect of the present invention, there is provided a method of installing an integrated file in a computing device having an open architecture platform, the integrated file corresponding to the open architecture platform, the method including: receiving, by the computing device, a first package file comprising at least one installation target file to be installed in the computing device and a metadata file; determining an installation target file, from the at least one installation target file, to be installed according to an analysis of the metadata file; and installing the determined installation target file in the computing device.

According to still another aspect of the present invention, there is provided a computer-readable recording medium implemented by an image forming apparatus having an open architecture platform, the computer-readable recording medium including: a package file comprising at least one installation target file; and a metadata file that is analyzed by the image forming apparatus to determine an installation target file, from the at least one installation target file, to be installed in the image forming apparatus according to the open platform architecture of the image forming apparatus.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram illustrating an image forming apparatus to install an integrated file therein, according to an embodiment of the present invention;

FIG. 2 is a diagram illustrating a package file, according to an embodiment of the present invention; and

FIG. 3 is a flowchart illustrating a method of installing an integrated file in an image forming apparatus, according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

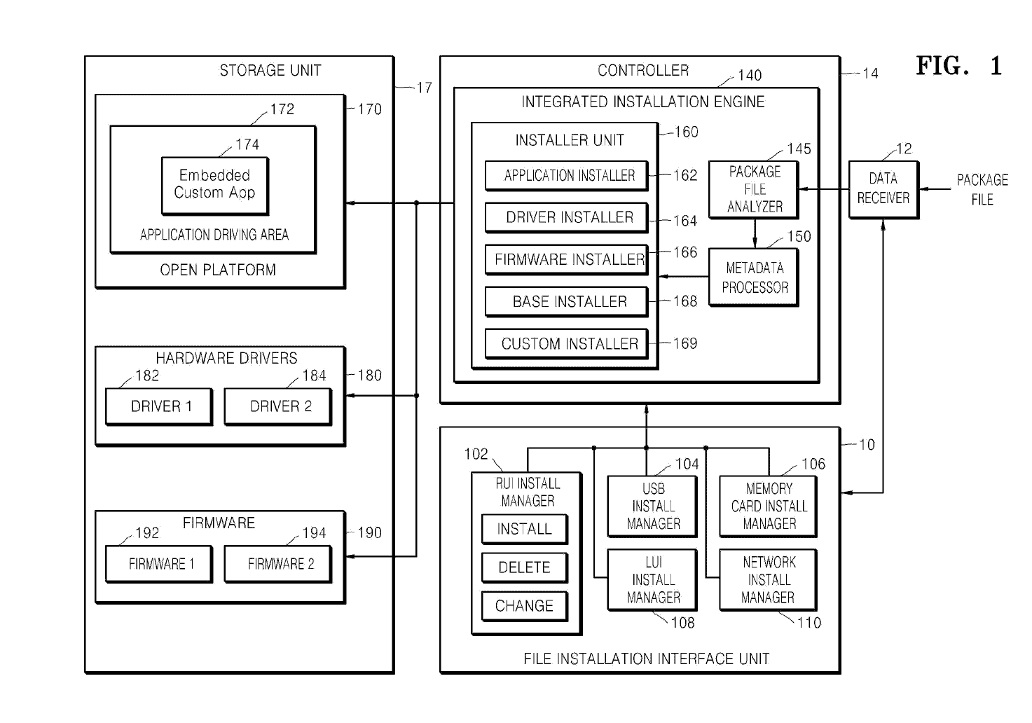

FIG. 1 is a block diagram illustrating an image forming apparatus to install an integrated file therein, according to an embodiment of the present invention. Referring to FIG. 1, the image forming apparatus includes a data receiver 12, a controller 14, a storage unit 17, and a file installation interface unit 10.

The data receiver 12 receives a first package file to be installed in the image forming apparatus, and includes hardware resources to transmit and/or to receive data (such as a universal serial bus (USB) port, a memory slot, and a network card). The first package file may be provided via a local interface that transmits and/or receives the first package file in the image forming apparatus, a network interface, a USB port connected to at least one portable storage medium (such as a USB memory), and/or a memory slot connected to at least one memory card. However, it is understood that aspects of the present invention are not limited thereto. For example, according to other aspects, the first package file may be externally transmitted via an embedded web server of the image forming apparatus.

The storage unit 17 stores installation target files installed in the image forming apparatus and management information of the installation target files. The storage unit 17 may be a hard disk built in the image forming apparatus, though aspects of the present invention are not limited thereto. For example, according to other aspects, the storage unit 17 may be a flash memory or a read only memory. The storage unit 17 includes an area of an open platform 170 that enables an external application to be executed by publicizing an application program interface, an area of hardware drivers 180 that stores a driver to drive a hardware device, and a domain of firmware 190 that stores firmware. That is, aspects of the present invention provide an open platform printer or multifunction device that installs a driver and firmware to drive an open platform and hardware supporting application installation.

Accordingly, the open platform 170 is a platform that enables an external application program to operate by publicizing an application program interface (API). Also, an application driving domain 172 is a part of the open platform 170, and is an area where the external application is operated. Furthermore, an embedded custom application 174 is an application program additionally installed by a user or an administrator, aside from a previously installed application. The embedded custom application 174 is developed in an embedded form (for example, in a Java or C language, or a language supported in other platforms). The embedded custom application 174 may be formed of one or more files.

The hardware drivers 180 are a set of device drivers 182 and 184, and may include a scan card driver and a fix chip driver. The device drivers 182 and 184 are driver files to control communication between a platform of the image forming apparatus and hardware devices. While FIG. 1 illustrates only two device drivers 182 and 184, it is understood that the hardware drivers 180 may include more than the two device drivers 182 and 184 in other embodiments.

The firmware 190 is a set of firmware 192 and 194 installed on hardware devices in the image forming apparatus. The firmware 192 and 194 control hardware, and may be main board firmware, scan board firmware, etc. While FIG. 1 illustrates only two firmware 192 and 194, it is understood that the firmware 190 may include more than the two firmware 192 and 194 in other embodiments.

The controller 14 analyzes a metadata file describing information about the first package file, stores the installation target files in the storage unit 17, and installs a file to be installed in the image forming apparatus when the file to be installed is determined according to a result of the metadata analysis. In other words, the controller 14 separates and analyzes the metadata file from the first package file, manages installation target files installed in the image forming apparatus, and installs a file to be installed in the image forming apparatus when the file is determined after the result of the analysis. The controller 14 includes an integrated installation engine 140 for general installation operations. The integrated installation engine 140 processes metadata by receiving and analyzing a package file, and performs an installation operation by calling an installer according to a file. The integrated installation engine 140 includes a package file analyzer 145, a metadata processor 150, and an installer unit 160.

The package file analyzer 145 decompresses a compressed package file, which is a package of software programs to be installed in the image forming apparatus, analyzes information of the package file, detects types of applications, drivers, and firmware, and separates a metadata file for describing package file information from the package file. When another package file exists in the package file, the package file analyzer 145 recursively processes the other package file.

The metadata processor 150 manages a file installed in the image forming apparatus by analyzing the metadata file. Accordingly, when a file to be installed is determined as a result of the analysis, the metadata processor 150 requests an installer to install the file. The metadata file is a file in a text form describing information of a file included in the package file. The metadata file may include name and version information of each file in the package file, dependency information indicating whether a file is dependent on another file, license information, code sign information indicating whether the package file is made by a reliable organization, setting information used in executing an application program, information indicating whether a new installer is installed, and/or end user license agreement (EULA) information requesting agreement of a user before installation. The metadata processor 150 performs operations such as recording the installation information, checking the license information, checking the code sign information, and checking the EULA information. Also, the metadata processor 150 installs a new file when there is no existing file information by analyzing version information of a file in the metadata file, and updates a previously installed file when a file having a different version from the previously installed file is requested to be installed. When there is no installer to install the file after analyzing the metadata file, the metadata processor 150 installs an installer, and installs the file by using the installer.

The installer unit 160 installs, revises, and/or changes files in the package file in the image forming apparatus. Furthermore, the installer 160 includes an application installer 162, a driver installer 164, a firmware installer 166, a base installer 168, and a custom installer 169. In other words, the installer unit 160 is a set of installers that install, revise, delete, and/or change an application program, a driver, and firmware in a system, and install files in the package file. When a new installer is included in the package file, the new installer is added to the installer unit 160, and a new installation operation may be dynamically extended. The application installer 162 installs, revises, deletes, and/or changes an application program in the open platform 170 of the storage unit 17. The driver installer 164 dynamically or passively (reboot requested) installs a driver in an operating system of the image forming apparatus. The firmware installer 166 updates firmware by, for example, directly transmitting the firmware to hardware. The base installer 168 stores, revises, and/or updates resource and version information in a memory (not shown) of the firmware installer 168. When a file that cannot be installed by using existing firmware is to be installed, the custom installer 169 included in the package file is installed before the file in order to install the file.

The file installation interface unit 10 provides an interface to install the file, and includes a remote user interface (RUI) install manager 102, a USB install manager 104, a memory card install manager 106, a local user interface (LUI) install manager 108, and a network install manager 110. The RUI install manager 102 is a remote administrator program, wherein a user or an administrator externally connects to the image forming apparatus via a web browser. The RUI install manager 102 installs, deletes, and/or changes a file in the image forming apparatus by transmitting the package file to an integrated installation engine 140 of the controller 14. The USB install manager 104 installs, deletes, and/or changes a file in the image forming apparatus by transmitting the package file to the integrated installation engine 140 of the controller 14 via a USB port connected to a host computer by using a USB cable.

When a memory stick storing the package file is directly connected to the image forming apparatus, the memory card install manager 106 installs, deletes, and/or changes the package file read by a memory stick reader in the image forming apparatus. In other words, a reader, that directly connects a memory stick (such as a USB memory stick, SD card, flash memory, etc.) is built in the image forming apparatus, and the memory card install manager 106 enables a user to install or update a PAR (plugin archive) file by storing the PAR file in the memory stick and then inserting the memory stick into the image forming apparatus.

The LUI install manager 108 provides an installation screen built in the image forming apparatus, and enables the integrated installation engine 140 of the controller 14 to install a file by remotely receiving the package file via the installation screen, and/or to revise or delete a previously installed package file. In other words, the LUI install manager 108 provides an installation screen on a LUI, and supports the integrated installation engine 140 to install a package file by remotely receiving the package file, and/or revise or delete a previously installed PAR file.

The network install manger 110 enables the integrated installation engine 140 to install, delete, and/or change a file by transmitting the package file to the integrated installation engine 140 via a network protocol. In other words, the network install manager 110 may transmit a PAR file to a printer or a multifunction device via a network as if the PAR file is output data, thereby installing the PAR file in the printer or the multifunction device, like outputting a file via a network printing protocol, such as an Internet printing protocol (IPP) or a line printer remote protocol (LPR). The network install manager 110 may be divided into an IPP install manager and an LPR install manager according to a supported port.

Meanwhile, the first package file includes an application program, a device driver, a printer driver, firmware, a custom installer, and/or a data file used in file installation. Also, the first package file may be a PAR file.

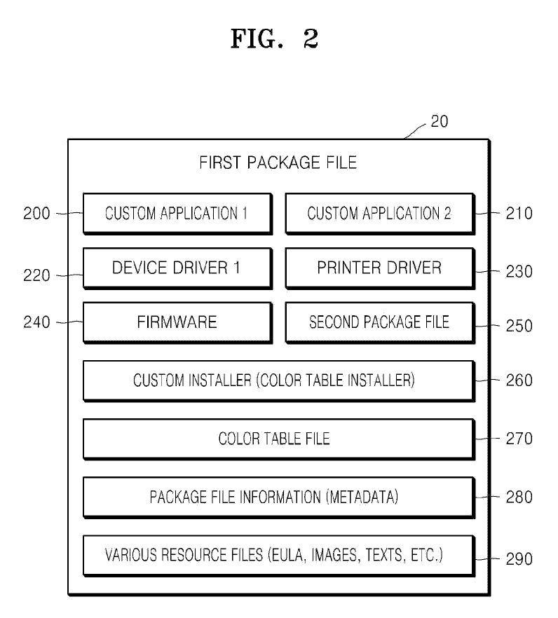

FIG. 2 is a diagram illustrating a first package file 20, according to an embodiment of the present invention. Referring to FIG. 2, the first package file 20 is a special format for integrated installation. Specifically, the first package file 20 has a structure in which one or more applications 200 and 210, one or more drivers including a device driver 220 and a printer driver 230, and/or one or more pieces of firmware 240 may be simultaneously installed.

As illustrated, the first package file 20 includes a second package file 250, i.e., the first package file 20 recursively includes the second package file 250. However, it is understood that in other embodiments, the first package file 20 does not include another package file, or may include a plurality of package files. When a color table file 270, which cannot be installed by using existing firmware, is to be installed, a custom installer 260 is a new installer that is dynamically added so as to install the color table file 270.

A package file information (metadata) 280 is a metadata setting file describing file information in the package file 20. The package file information 280 may include name and version information about each file in a package file, license information, code sign information, and/or various pieces of setting information used for EULA, a user's inquiry, or executing other applications. Resource files 290 are various data files (EULA, texts, images, etc.) used for installation.

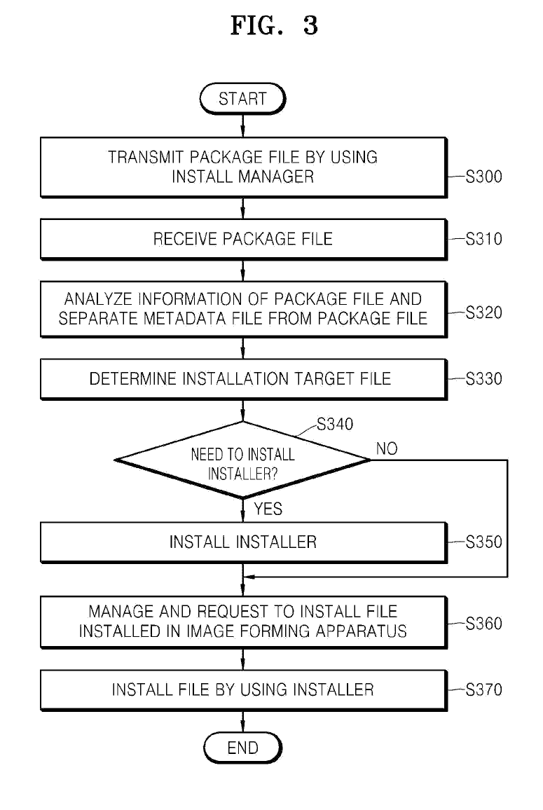

FIG. 3 is a flowchart illustrating a method of installing an integrated file in an image forming apparatus, according to an embodiment of the present invention. Operations of the image forming apparatus and the method will now be described with reference to FIGS. 1 through 3. Referring to FIGS. 1 through 3, one of install managers 102, 104, 106, 108, and 110 of the file installation interface unit 10 transmits a package file to the data receiver 12 in operation S300. The package file is transmitted from the data receiver 12 to the integrated installation engine 140 of the controller 14. For example, when the package file is installed by using the RUI install manager 102, a user or an administrator calls the RUI install manager 102 from a computer to obtain a screen, selects the package file (PAR file) in a storage device (for example, a hard disk drive) of the computer, and clicks an install button, thereby transmitting the package file to the integrated installation engine 140 via the data receiver 12.

The package file analyzer 145 of the integrated installation engine 140 receives the package file from the data receiver 12 in operation S310, analyzes information of the package file by decompressing the package file (if the package file is compressed) and separates a metadata file describing package file information from the package file in operation S320, and transmits the metadata file to the metadata processor 150. As described above, the package file analyzer 145 analyzes files in a first package file by decompressing the first package file. Furthermore, when a second package file is included in the first package file, the package file analyzer 145 decompresses the second package file in a recursive call method so as to first analyze the second package file. Then, the metadata file is transmitted to the metadata processor 150 so as to process internal information.

The metadata processor 150 manages software files installed in the image forming apparatus by analyzing the metadata file, and determines a file to be installed in the image forming apparatus as a result of the analysis in operation S330. Accordingly, the metadata processor 150 requests a corresponding installer 160, 162, 164, 166, or 168 to install the file in operation S360.

After analyzing the metadata file, the metadata processor 150 analyzes version information of a file in the metadata file, such that when there is no existing file information, the file is newly installed, or when a file having a different version from a previously installed file is requested, updates the previously installed file. In other words, the metadata processor 150 analyzes the metadata file received from the package file analyzer 145, records installation information, and stores information of a corresponding package file (PAR file), so that the package file may be later revised and/or deleted.

Also, in some non-limiting embodiments, the metadata processor 150 determines whether an installer has a suitable license by obtaining license information, and determines whether the PAR file is prepared by a reliable organization by analyzing cod sign information. Also, when there is EULA information, agreement of the user is obtained before installation. The EULA information is transmitted to the RUI install manager 102 that requested to install the PAR file, and a following operation is performed after receiving agreement or disapproval of the user.

While determining an installation target file, the metadata processor 150 checks whether a printer driver exists in the first or second package file. When the printer driver exists, installation is determined by checking version information of a printer driver installed in a host connected to the image forming apparatus. When the printer driver is determined to be installed, the printer driver is provided to the host connected to the image forming apparatus.

A corresponding installer 160, 162, 164, 166, or 168 of the installer unit 160 installs the file in the image forming apparatus in operation S370. The metadata processor 150 checks the internal information, and then requests the installer unit 160 to install an actual file according to information about each application, driver, and/or firmware files. Then, according to version information of the file transmitted from the metadata processor 150, the installer unit 160 newly installs the file when there is no existing file information, or updates the file, when the file has a different version from a previously installed file.

Meanwhile, when it is determined that there is no installer to install the file to be installed after analyzing the metadata file (operation S340), the metadata processor 150 installs the installer in operation S350, and requests the installer to install the file to be installed in operation S360. In other words, when the file is unable to be installed by using existing firmware, the installer to install the file is installed first so that the installer installs the file. For example, when firmware using a color table (scan color table or a copy color table) used by the image forming device exists but there is no method of installing a new color table in the firmware, a color table installer may be included in a package file (PAR file). In more detail, when a color table installer 169 (i.e., a custom installer 169) is included in the package file (PAR file), the installer unit 160 newly adds the custom installer 169. Then, when a color table file is requested to be installed, the custom installer 169 installs the color table file that could not previously be installed in the existing firmware.

According to the aspects of the present invention, there is provided a method of installing various types of files at once by using an integrated file. Thus, the various types of files are easily installed, and versions of the files are managed by supporting metadata. Also, all binary files used for internal operations are installed at once, and various installation methods are realized by using a corresponding integrated installation engine in a conventional USB, 9100 port, and web service. A user may install a file by using any method that was used before, and a device may install the file even when the file is received via various paths. Accordingly, a version of the file is efficiently managed. Also, a plurality of driver and firmware files are installed in one integrated file, and thus operations performed by a user are minimized.

Recently, various types of files are installed in digital devices, and thus a method of supporting an integrated installation process is required. Specifically, open architecture platforms that have recently been released receive various binary files (such as applications, data, firmware, drivers, etc.) that are used in a conventional computer. Accordingly, aspects of the present invention may be applied to any device that receives various types of files. Moreover, the method according to aspects of the present invention may be used in a multifunction device platform supporting an open architecture. Also, a file that may be installed in an image forming apparatus, such as a printer or a multifunction device, according to aspects of the present invention is not limited to an application, firmware, or a driver. For example, the file may also be a software program for any component of the image forming apparatus by adding a new installation method.

While not restricted thereto, aspects of the present invention can also be embodied as computer (including all apparatuses including an information processing function) readable codes on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. Aspects of the present invention may also be realized as a data signal embodied in a carrier wave and comprising a program readable by a computer and transmittable over the Internet.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of installing an integrated file in an image forming apparatus, the method comprising:
receiving, by the image forming apparatus, a first package file comprising at least one installation target file to be installed in the image forming apparatus and a metadata file;
analyzing the metadata file;
determining an installation target file, from the at least one installation target file, to be installed according to a result of the analyzing; and
installing the determined installation target file in the image forming apparatus.

2. The method as claimed in claim 1, wherein the at least one installation target file comprises an application, a piece of firmware, a device driver, and/or a printer driver.

3. The method as claimed in claim 1, wherein the first package file further comprises a second package file, a resource file, and/or a custom installer for the image forming apparatus to install the determined installation target file.

4. The method as claimed in claim 1, wherein:
the first package file further comprises a second package file; and
the determining of the installation target file comprises determining the installation target file from the at least one installation target file of the first package file and from at least one installation target file of the second package file.

5. The method as claimed in claim 1, wherein the metadata file comprises name and version information of each of the at least one installation target file, license information, code sign information, setting information used to execute an application, information indicating installation of a new installer, and/or end user license agreement (EULA) information requesting agreement of a user before the installing.

6. The method as claimed in claim 2, wherein:
the analyzing of the metadata file comprises comparing version information of a printer driver installed in a host connected to the image forming apparatus with version information, included in the metadata file, of the printer driver comprised in the first package file; and
the determining of the installation target file to be installed comprises determining the printer driver to be the installation target file to be installed and providing the printer driver to the host connected to the image forming apparatus when the version information of the printer driver comprised in the first package file is more recent than the version information of the printer driver installed in the host.

7. The method as claimed in claim 1, wherein the determining of the installation target file to be installed comprises indicating one or more installation target files of the at least one installation target file according to the result of the analyzing, wherein the indicated one or more installation target files are selected to be installed.

8. The method as claimed in claim 1, wherein the receiving of the first package file comprises receiving the first package file via a local/network interface that transmits and receives the first package file in the image forming apparatus, a universal serial bus (USB) port connected to at least one portable storage medium, and/or a memory slot connected to at least one memory card.

9. The method as claimed in claim 1, wherein the receiving of the first package file comprises receiving the first package file via an external transmission through an embedded web server of the image forming apparatus.

10. The method as claimed in claim 1, wherein the determining of the installation target file to be installed comprises: determining the installation target file to be installed when no version of the installation target file exists in the image forming apparatus or when a different version of the installation target file exists in the image forming apparatus according to the analyzing of version information of the installation target file in the metadata file.

11. The method as claimed in claim 10, wherein the installing of the determined installation target file comprises updating the different version of the installation target file existing in the image forming apparatus with the installation target file comprised in the first package file.

12. The method as claimed in claim 1, wherein the installing of the determined installation target file comprises, when an installer for the determined installation target file does not exist in the image forming apparatus, installing the installer and installing the determined installation target file by using the installer.

13. An image forming apparatus comprising:
a data receiver to receive a first package file comprising at least one installation target file to be installed in the image forming apparatus and a metadata file;
a storage unit to store the at least one installation target file and management information of the at least one installation target file; and
a controller to analyze the metadata file describing information about the first package file, to store the at least one installation target file in the storage unit, to determine an installation target file, from the at least one installation target file, to be installed according to the analysis of the metadata file, and to install the determined installation target file in the image forming apparatus.

14. The image forming apparatus as claimed in claim 13, wherein the at least one installation target file comprises an application, a piece of firmware, a device driver, and/or a printer driver.

15. The image forming apparatus as claimed in claim 13, wherein the first package file further comprises a second package file, a resource file, and/or a custom installer for the image forming apparatus to install the determined installation target file.

16. The image forming apparatus as claimed in claim 13, wherein the data receiver receives the first package file via a local/network interface that transmits and receives the first package file in the image forming apparatus, a universal serial bus (USB) port connected to at least one portable storage medium, and/or a memory slot connected to at least one memory card.

17. The image forming apparatus as claimed in claim 13, wherein the data receiver receives the first package file via an external transmission through an embedded web server of the image forming apparatus.

18. The image forming apparatus as claimed in claim 13, wherein the metadata file comprises name and version information of each of the at least one installation target file, license information, code sign information, setting information used to execute an application, information indicating installation of a new installer, and end user license agreement (EULA) information requesting agreement of a user before installation.

19. The image forming apparatus as claimed in claim 13, wherein the controller comprises:
a package file analyzer to analyze information of the first package file and to separate the metadata file from the first package file;
a metadata processor to manage the at least one installation target file by analyzing the metadata file, to determine the installation target file to be installed, and to request an installer to install the determined installation target file; and
an integrated installation engine comprising the installer to install the determined installation target file.

20. The image forming apparatus as claimed in claim 19, wherein the package file analyzer determines the installation target file from the first package file or a second package file comprised in the first package file.

21. The image forming apparatus as claimed in claim 19, wherein the metadata processor analyzes version information of a file, of the at least one installation target file, in the metadata file, and determines the file to be the installation target file to be installed when no version of the file is previously installed in the image forming apparatus or when a different version of the file is previously installed in the image forming apparatus according to the analysis.

22. The image forming apparatus as claimed in claim 19, wherein when an installer to install the determined installation target file to be installed does not exist in the image forming apparatus, the metadata processor installs the installer installs the determined installation target file by using the installer.

23. The image forming apparatus as claimed in claim 19, wherein the metadata processor displays, on a display, one or more installation target files of the at least one installation target file according to a result of the analysis of the metadata file, wherein the displayed one or more installation target files are selectable by a user for installation.

24. The image forming apparatus as claimed in claim 19, wherein the installer comprises:
an application installer to install, delete, and/or update an application in an open platform of the storage unit;
a driver installer to install a driver in an operating system of the image forming apparatus;
a firmware installer to update and/or install firmware in hardware of the image forming apparatus;
a base installer to store, revise, and/or update resource and version information; and
a custom installer included in the first package file and, when the determined installation target file is unable to be installed by using existing firmware in the image forming apparatus, installs the determined installation target file by being installed in the image forming apparatus before the determined installation target file.

25. The image forming apparatus as claimed in claim 13, further comprising a file installation interface unit to install the first package file or a second package file comprised in the first package file.

26. The image forming apparatus as claimed in claim 13, wherein the storage unit comprises:
an area of an open platform to enable an external application to be executed in the image forming apparatus by publicizing an application program interface;
a hardware driver area to store one or more drivers that operate one or more hardware devices of the image forming apparatus; and
an area of firmware to store one or more pieces of firmware.
